(19) United States
(12) Patent Application Publication
(10) Pub. No.: US 2022/0169269 A1
(43) Pub. Date: Jun. 2, 2022

(54) DRIVING ASSISTANCE METHOD AND VEHICLE-MOUNTED DEVICE

(71) Applicant: Mobile Drive Netherlands B.V., Amsterdam (NL)

(72) Inventor: CHENG-KUO YANG, New Taipei (TW)

(21) Appl. No.: 17/533,400

(22) Filed: Nov. 23, 2021

(30) Foreign Application Priority Data
Nov. 30, 2020 (CN) 202011380218.6
Dec. 29, 2020 (TW) 109146746

(51) Int. Cl. B60W 50/08; G06V 40/10; G06V 20/59; B60W 40/08; B60W 40/06

(52) U.S. Cl. CPC B60W 50/082; G06V 40/103; G06V 20/593; B60W 40/08; B60W 40/06; B60W 2540/049; B60W 2556/40; B60W 2540/043; B60W 2040/0881; B60W 2040/0809; B60W 2556/50; B60W 2710/0677

(57) ABSTRACT

A driving assistance method applied to a vehicle is provided. The method includes capturing at least one image of occupants of the vehicle using a camera module. Once occupant attributes of the vehicle are recognized based on the captured image, a driving mode of the vehicle is changed based on the occupant attributes of the vehicle.

This application claims priority to Chinese Patent Application No. 202011380218.6 filed on Nov. 30, 2020, and Taiwanese Application No. 109146746 filed on Dec. 29, 2020, the contents of which are incorporated by reference herein.

### FIELD

The present disclosure relates to traffic safety control technologies, in particular to a driving assistance method, and a vehicle-mounted device.

### BACKGROUND

In order to enhance a driving experience or provide driving assistance under different traffic conditions, a vehicle can provide a variety of driving modes for a driver. However, the driver needs to switch manually between the driving modes. Most drivers are not sure when or where to switch to which driving mode.

### BRIEF DESCRIPTION OF THE DRAWINGS

FIG. 1 shows a flowchart of one embodiment of a driving assistance method of the present disclosure.

FIG. 2 shows a schematic block diagram of one embodiment of modules of a driving assistance system of the present disclosure.

FIG. 3 shows a schematic block diagram of one embodiment of a vehicle-mounted device in a vehicle of the present disclosure.

### DETAILED DESCRIPTION

In order to provide a clearer understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

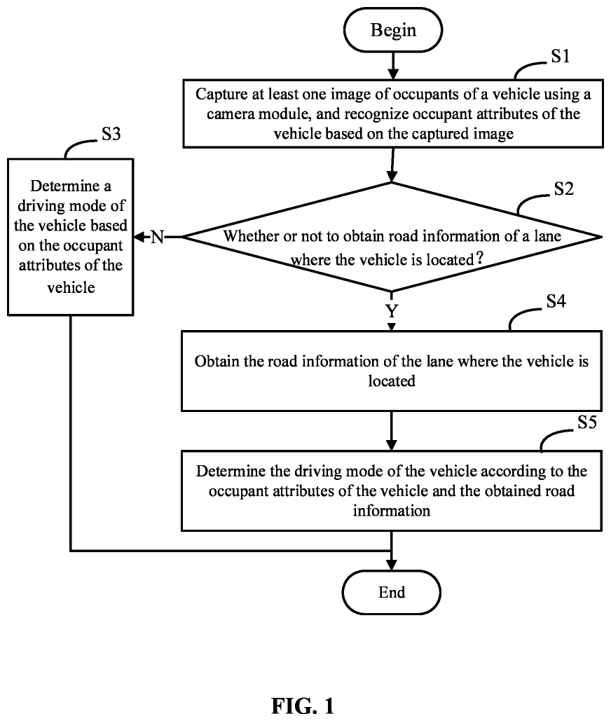

FIG. 1 shows a flowchart of one embodiment of a driving assistance method of the present disclosure.

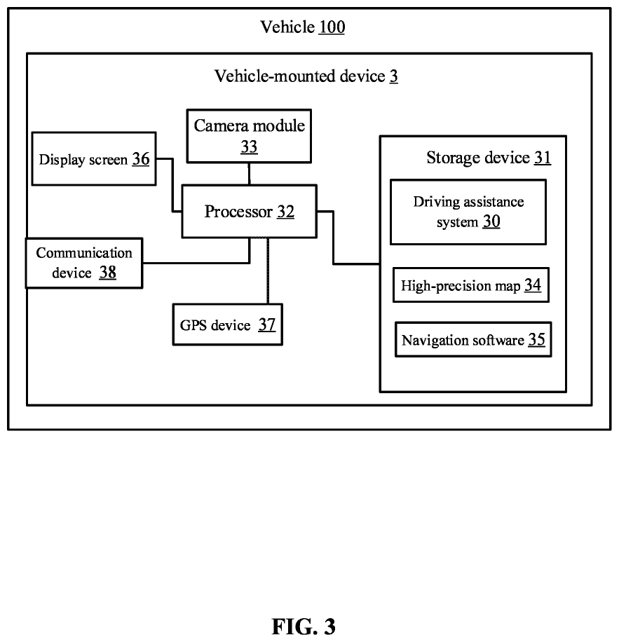

In one embodiment, the driving assistance method can be applied to a vehicle-mounted device of a vehicle (e.g., a vehicle-mounted device 3 of a vehicle 100 in FIG. 3). For a vehicle-mounted device that needs to perform a driving assistance, the function for the driving assistance provided by the method of the present disclosure can be directly integrated on the vehicle-mounted device, or run on the vehicle-mounted device in the form of a software development kit (SDK).

As shown in FIG. 1, the driving assistance method includes the following blocks. According to different requirements, an order of the blocks in the flowchart can be changed, and some blocks can be omitted.

At block S1, the vehicle-mounted device captures at least one image of occupants of the vehicle using a camera module, and recognizes occupant attributes of the vehicle based on the captured image.

In an embodiment, the camera module includes one or more cameras installed inside the vehicle (hereafter referred to as internal cameras). The one or more internal cameras can be installed at any position inside the vehicle, as long as the vehicle-mounted device can capture images of all the occupants of the vehicle by using the one or more internal cameras. For example, the vehicle-mounted device can use one internal camera to capture images of the driver of the vehicle, and use another internal camera to capture images of passengers of the vehicle. Of course, the vehicle-mounted device can use only one internal camera to capture images of the driver and all the passengers of the vehicle.

In one embodiment, the occupant attributes of the vehicle include, but are not limited to, a total number of occupants of the vehicle, an identity of the driver, an age of the driver, a gender of the driver, an identity of each passenger, an age and a gender of each passenger, and/or a composition relationship of all passengers in the vehicle.

It should be noted that the passengers of the vehicle are all occupants in the vehicle except the driver.

In an embodiment, the composition relationship of all passengers of the vehicle can refer to a couple or a family. In one embodiment, the vehicle-mounted device can determine the age and the gender of each occupant by using a gender and age recognition algorithm based on face image. In one embodiment, the vehicle-mounted device pre-stores identity information of each occupant who has ever taken the vehicle and pre-stores a relationship between the occupants in a preset database. In one embodiment, the identity information of each occupant includes, but is not limited to, a name of each occupant, a face image, and a role of each occupant when the each occupant takes the vehicle (i.e., when the each occupant takes the vehicle, the each occupant is a driver or a passenger), and a driving mode of the vehicle when the each occupant takes the vehicle.

In one embodiment, the driving mode of the vehicle may include, but is not limited to, a normal mode, a sport mode, and a highway mode. It should be noted that different driving modes have different requirements on the power of the vehicle, wherein the normal mode has a lowest requirement on the power of the vehicle, the sport mode has a second highest requirement on the power of the vehicle, and the highway mode has a highest requirement on the power of the vehicle. In other words, the requirement on the power of the vehicle of the sport mode is lower than the highway mode but is higher than the normal mode. In one embodiment, the composition relationship between the occupants may refer to whether a relationship between the occupants is a couple relationship, or a family relationship, etc. For example, the relationship between A and B is the couple relationship. The relationship between C, D, and E is the family relationship. In one embodiment, when the vehicle-mounted device cannot determine the identity of any one occupant from the database, the vehicle-mounted device determines that the any one occupant is a stranger. In one embodiment, the vehicle-mounted device can use a face recognition algorithm to determine whether each occupant is a stranger based on the face image pre-stored in the database and the captured images of each occupant.

Specifically, when the vehicle-mounted device recognizes that the captured face image of any one occupant does not match the face image prestored in the database, the vehicle-mounted device can determine that the any one occupant is a stranger. Conversely, when the captured face image of the any one occupant matches the face image pre-stored in the database, the vehicle-mounted device can determine that any one occupant is an occupant who has ever taken the vehicle. Therefore, the vehicle-mounted device can also obtain other identity information of the any one occupant from the database based on the captured face image of the occupant, such as the name, the role of the any one occupant, the driving mode of the vehicle, and the relationship between the any one occupant and other occupants when the any one occupant takes the vehicle, etc.

At block S2, the vehicle-mounted device prompts whether or not to obtain road information of a lane where the vehicle is located. When a confirmation signal which is indicating the road information of the lane is not needed (hereinafter “first confirmation signal”) is received, the process goes to block S3. When a confirmation signal which is indicating the road information of the lane is needed (hereinafter “second confirmation signal”) is received, the process goes to block S4.

In one embodiment, the vehicle-mounted device may issue the prompt by voice or by displaying a dialog box on a display screen of the vehicle-mounted device to prompt the driver whether or not to obtain the road information of the lane where the vehicle is located. The vehicle-mounted device may determine whether or not to obtain the road information of the lane where the vehicle is located according to voice input information or a user's operation on the dialog box.

At block S3, when the first confirmation signal is received, the vehicle-mounted device determines a driving mode of the vehicle based on the occupant attributes of the vehicle.

In one embodiment, the determining a driving mode of the vehicle based on the occupant attributes of the vehicle includes: when the occupant attributes indicate that the vehicle includes only one occupant, switching a current driving mode of the vehicle to a driving mode corresponding to the identity of the occupant, according to the identity of the occupant.

Specifically, the switching the current driving mode of the vehicle to the driving mode corresponding to the identity of the occupant, according to the identity of the occupant includes: determining whether the occupant is a stranger by searching the database; switching, when the occupant is a stranger, the current driving mode of the vehicle to a driving mode corresponding to the age and the gender of the occupant; and switching, when the occupant is not a stranger, the current driving mode of the vehicle to a driving mode corresponding to the occupant that is stored in the database.

In one embodiment, the vehicle-mounted device pre-defines driving modes corresponding to different ages and genders. Therefore, when the vehicle-mounted device recognizes the age and the gender of any one occupant, the vehicle-mounted device can determine the driving mode corresponding to the age and the gender of the any one occupant. For example, the vehicle-mounted device can predefine minors and elderly corresponding to the economic model regardless of the genders of r the minors and elderly; and predefine young males and females corresponding to the sport mode; and predefine young males corresponding to the highway mode.

In one embodiment, the determining a driving mode of the vehicle based on the occupant attributes of the vehicle further includes: when the occupant attributes indicate that the vehicle includes more than one occupant (for example, two, three, or four occupants), switching the driving mode of the vehicle according to a combination of the age, the gender, and/or the total number of all the occupants of the vehicle.

Specifically, the switching the driving mode of the vehicle according to the combination of the age, the gender, and/or the total number of all the occupants of the vehicle includes: determining whether the more than one occupant is strangers by searching the database; when any one occupant of the more than one occupant is not a stranger, determining the driving mode corresponding to the any one occupant from the database; and when the any one occupant is a stranger, determining the driving mode according to the gender and age of the any one occupant.

In one embodiment, the vehicle-mounted device further switches the driving mode of the vehicle to a target driving mode according to the determined driving mode corresponding to each of the more than one occupant, and the target driving mode is the driving mode that requires the lowest power of the vehicle among all the determined driving modes.

For example, assuming that there are two occupants of the vehicle in total, and the driving modes corresponding to each of the two occupants are the normal mode and highway mode, then the vehicle-mounted device sets the normal mode as the target driving mode, and the driving mode of the vehicle is switched to the normal mode.

As another example, assuming that there are three occupants of the vehicle in total, and the driving modes corresponding to each of the three occupants are the sport mode, the sport mode and highway mode, then the vehicle-mounted device switches the driving mode of the vehicle to the sport mode.

In an embodiment of the present disclosure, when the vehicle-mounted device recognizes that one of the more than one occupant is a stranger, and the more than one occupant includes females, elderly, or children, the vehicle-mounted device determines that the driving mode corresponding to the more than one occupant is the normal mode. In another embodiment of the present disclosure, when vehicle-mounted device recognizes that one of the more than one occupant is a stranger, and the more than one occupant only includes males and young people, the vehicle-mounted device determines that the driving mode corresponding to the more than one occupant is the sport mode.

In one embodiment, when the vehicle includes a stranger, the vehicle-mounted device further stores the identity information of the stranger and the current driving mode of the vehicle in the database.

At block S4, when the second confirmation signal is received, the vehicle-mounted device obtains the road information of the lane where the vehicle is located.

In one embodiment, the road information of the lane where the vehicle is located includes a type of the lane where the vehicle is located, and real-time road conditions of the lane where the vehicle is located.

In one embodiment, the type of the lane where the vehicle is located refers to whether the lane where the vehicle is located is a highway, a mountain road, an urban road, a fast lane, an elevated road, or a slow lane. In an embodiment, the vehicle-mounted device may obtain the type of the lane where the vehicle is located from a high-precision map.

In one embodiment, the real-time road condition of the lane where the vehicle is located refers to whether the road condition of the lane where the vehicle is located is light traffic or heavy traffic.

In one embodiment, the obtaining the real-time road conditions of the lane where the vehicle is located includes: obtaining an external image by taking an image of a scene in front of the vehicle using the camera module; obtaining the real-time road conditions of the lane where the vehicle is located by identifying the external image. In an embodiment, the camera module may further include one or more cameras installed outside the vehicle (hereinafter referred to as external cameras). An installation position of the external camera may be any position outside the vehicle, as long as the vehicle-mounted device can use the one or more external cameras to obtain external images of the vehicle.

In other embodiments, the vehicle-mounted device may obtain the real-time road conditions of the lane where the vehicle is located using a navigation software. In other embodiments, the vehicle-mounted device may also obtain the real-time road conditions of the lane where the vehicle is located through a communication device.

At block S5, the vehicle-mounted device determines the driving mode of the vehicle according to the occupant attributes of the vehicle and the obtained road information.

In one embodiment, the determining the driving mode of the vehicle according to the occupant attributes of the vehicle and the obtained road information includes: when the vehicle includes only one occupant, and the only one occupant is an elderly person, regardless of the road information of the lane where the vehicle is located, switching a current driving mode of the vehicle to the normal mode; and when the only one occupant is a young person, determining the driving mode according to the obtained road information.

Specifically, when the only one occupant is a young person, the lane where the vehicle is located is a highway or a mountain road, and the traffic in the lane where the vehicle is located is light traffic, the vehicle-mounted device switches the current driving mode to the sport mode; and when the traffic in the lane where the vehicle is located is the heavy traffic, the vehicle-mounted device switches the current driving mode to the normal mode.

For another example, when the occupant is a young person and the lane where the vehicle is located is an urban highway, regardless of whether the traffic in the lane where the vehicle is located is light traffic or heavy traffic, the vehicle-mounted device switches the current driving mode to the normal model.

In one embodiment, the determining the driving mode of the vehicle according to the occupant attributes of the vehicle and the obtained road information includes: when the vehicle includes more than one occupant, and the more than one occupant includes elders or minors, switching the current driving mode of the vehicle to the normal mode regardless of the road information of the lane where the vehicle is located; when the more than one occupant does not include elders and minors, determining the driving mode according to the road information of the lane where the vehicle is located.

For example, when the more than one occupant does not include the elderly and minors, the lane where the vehicle is located is a highway or a mountain road, and the traffic in the lane where the vehicle is located is light traffic, the vehicle-mounded device switches the current driving mode to the sport mode; and when the traffic in the lane where the vehicle is located is heavy traffic, the vehicle-mounded device switches the current driving mode to the normal mode.

In an embodiment of the present disclosure, when the road information of the lane where the vehicle is located is an urban road, and the more than one occupant includes females, the elderly, or children, the vehicle-mounted device determines that the driving mode of the vehicle should be switched to the normal mode. In another embodiment of the present disclosure, when the road information of the lane where the vehicle is located is an expressway, and the more than one occupant only includes young people, the vehicle-mounted device determines that the driving mode of the vehicle should be switched to the highway mode.

In one embodiment, the vehicle-mounted device may not directly switch the driving mode, but recommend the determined driving mode to the driver of the vehicle, and switch the driving mode in response to the driver's input. For example, the vehicle-mounted device may recommend a driving mode using a speaker or a display screen, and determine whether to switch the driving mode of the vehicle in response to the driver's input.

In one embodiment, the vehicle-mounted device further stores manually switched driving mode and the driver's identity in response to detecting a signal that the driver of the vehicle manually switches the driving mode. For example, if the driver manually switches to the normal mode, the vehicle-mounted device stores the normal mode and the driver's identity in the database when detecting the signal that the driver manually switched the driving mode. In one embodiment, the vehicle-mounted device obtains the road information of the lane where the vehicle is located from the high-precision map and obtains real-time road conditions of the lane where the vehicle is located from the navigation software, in response to detecting the signal that the driver of the vehicle manually switches the driving mode; and associating the manually switched driving mode with the obtained road information and real-time road conditions of the lane where the vehicle is located, and storing the associated information.

In one embodiment, the vehicle-mounted device further determines a common driving mode of the driver of the vehicle according to the manually switched driving modes stored in the history. In an embodiment, the vehicle-mounted device may count a number of times each driving mode is manually switched by the driver and set the driving mode with a most number of times as the common driving mode of the driver.

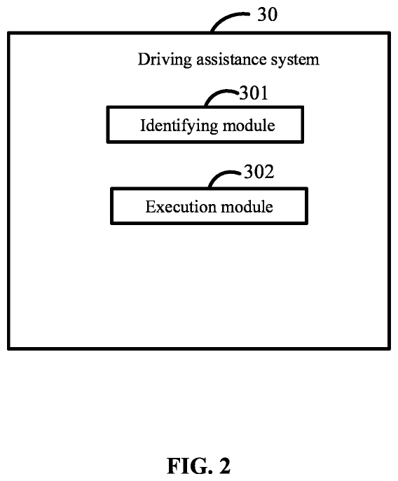

FIG. 1 introduces the driving assistance method of the present disclosure. In the following, with reference to FIG. 2 and FIG. 3, the software modules and the architecture of the hardware device for implementing the driving assistance method will be introduced. It should be understood that the described embodiments are for illustrative purposes only, and are not limited by this structure in the scope of the patent disclosure. FIG. 2 shows a schematic block diagram of an embodiment of modules of a driving assistance system 30 of the present disclosure.

In some embodiments, the driving assistance system 30 runs in a vehicle-mounted device. The driving assistance system 30 may include a plurality of modules. The plurality of modules can comprise computerized instructions in a form of one or more computer-readable programs that can be stored in a non-transitory computer-readable medium (e.g., a storage device 31 of the vehicle-mounted device 3 in FIG. 3), and executed by at least one processor (e.g., a processor 32 in FIG. 3) of the vehicle-mounted device to implement driving assistance function (described in detail in FIG. 1).

In at least one embodiment, the driving assistance system 30 may include a plurality of modules. The plurality of modules may include, but is not limited to, an identification module 301 and an execution module 302. The modules 301-302 can comprise computerized instructions in the form of one or more computer-readable programs that can be stored in the non-transitory computer-readable medium (e.g., the storage device 31 of the vehicle-mounted device 3), and executed by the at least one processor (e.g., a processor 32 in FIG. 3) of the vehicle-mounted device to implement driving assistance function (e.g., described in detail in FIG. 1).

The identification module 301 captures at least one image of occupants of the vehicle using a camera module, and recognizes occupant attributes of the vehicle based on the at least one captured image.

In an embodiment, the camera module includes one or more cameras installed inside the vehicle (hereafter referred to as internal cameras). The one or more internal cameras can be installed at any position inside the vehicle, as long as the identification module 301 can capture images of all the occupants of the vehicle by using the one or more internal cameras. For example, the identification module 301 can use one internal camera to capture images of the driver of the vehicle, and use another internal camera to capture images of the passengers of the vehicle. Of course, the identification module 301 can use only one internal camera to capture images of the driver and all the passengers of the vehicle.

In one embodiment, the occupant attributes of the vehicle include, but are not limited to, a total number of occupants of the vehicle, an identity of the driver, an age of the driver, a gender of the driver, an identity of each passenger, an age and a gender of each passenger, and/or a composition relationship of all passengers in the vehicle.

It should be noted that the passengers of the vehicle are all occupants in the vehicle except the driver.

In an embodiment, the composition relationship of all passengers of the vehicle can refer to a couple or a family. In one embodiment, the identification module 301 can determine the age and gender of each occupant by using a gender and age recognition algorithm based on face image. In one embodiment, the identification module 301 pre-stores identity information of each occupant who has ever taken the vehicle and pre-stores a relationship between the occupants in a preset database. In one embodiment, the identity information of each occupant includes, but is not limited to, a name of each occupant, a face image, and a role of each occupant when the each occupant takes the vehicle (i.e., when the each occupant takes the vehicle, the each occupant is a driver or a passenger), and a driving mode of the vehicle when the each occupant takes the vehicle.

In one embodiment, the driving mode of the vehicle may include, but is not limited to, a normal mode, a sport mode, and a highway mode. It should be noted that different driving modes have different requirements on the power of the vehicle, wherein, the normal mode has a lowest requirement on the power of the vehicle, the sport mode has a second highest requirement on the power of the vehicle, and the highway mode has a highest requirement on the power of the vehicle. In other words, the requirement on the power of the vehicle of the sport mode is lower than the highway mode but is higher than the normal mode.

In one embodiment, the composition relationship between the occupants may refer to whether a relationship between the occupants is a couple relationship, or a family relationship, etc. For example, the relationship between A and B is the couple relationship. The relationship between C, D, and E is the family relationship. In one embodiment, when the identification module 301 cannot determine the identity of any one occupant from the database, the identification module 301 determines that the any one occupant is a stranger. In one embodiment, the identification module 301 can use a face recognition algorithm to determine whether each occupant is a stranger based on the face image pre-stored in the database and the captured images of each occupant.

Specifically, when the identification module 301 recognizes that the captured face image of any one occupant does not match the face image prestored in the database, the identification module 301 can determine that the any one occupant is a stranger. Conversely, when the captured face image of the any one occupant matches the face image pre-stored in the database, the identification module 301 can determine that any one occupant is an occupant who has ever taken the vehicle. Therefore, the identification module 301 can also obtain other identity information of the any one occupant from the database based on the captured face image of the occupant, such as the name, the role of the any one occupant, the driving mode of the vehicle, and the relationship between the any one occupant and other occupants when the any one occupant takes the vehicle, etc.

The execution module 302 prompts whether or not to obtain road information of a lane where the vehicle is located. When a confirmation signal which is indicating the road information of the lane is not needed (hereinafter “first confirmation signal”) is received, the process goes to block S3. When a confirmation signal which is indicating the road information of the lane is needed (hereinafter “second confirmation signal”) is received, the process goes to block S4.

In one embodiment, the execution module 302 may issue the prompt by voice or by displaying a dialog box on a display screen of the vehicle-mounted device to prompt the driver whether or not to obtain the road information of the lane where the vehicle is located. The execution module 302 may determine whether or not to obtain the road information of the lane where the vehicle is located according to voice input information or a user's operation on the dialog box.

When the first confirmation signal is received, the execution module 302 determines the driving mode of the vehicle based on the occupant attributes of the vehicle.

In one embodiment, the determining the driving mode of the vehicle based on the occupant attributes of the vehicle includes: when the occupant attributes indicate that the vehicle includes only one occupant, switching a current driving mode of the vehicle to a driving mode corresponding to the identity of the occupant, according to the identity of the occupant.

Specifically, the switching the current driving mode of the vehicle to the driving mode corresponding to the identity of the occupant, according to the identity of the occupant includes: determining whether the occupant is a stranger by searching the database; switching, when the occupant is a stranger, the current driving mode of the vehicle to a driving mode corresponding to the age and the gender of the occupant; and switching, when the occupant is not a stranger, the current driving mode of the vehicle to a driving mode corresponding to the occupant that is stored in the database.

In one embodiment, the execution module 302 pre-defines driving modes corresponding to different ages and genders. Therefore, when the execution module 302 recognizes the age and gender of any one occupant, the execution module 302 can determine the driving mode corresponding to the age and gender of the any one occupant. For example, the execution module 302 can predefine minors and elderly corresponding to the economic model regardless of the genders of the minors and elderly; and predefine young females and males corresponding to the sport mode; and predefine young males corresponding to the highway mode.

In one embodiment, the determining the driving mode of the vehicle based on the occupant attributes of the vehicle further includes: when the occupant attributes indicate that the vehicle includes more than one occupant (for example, two, three, or four occupants), switching the driving mode of the vehicle according to a combination of the age, the gender, and/or the total number of all the occupants of the vehicle.

Specifically, the switching the driving mode of the vehicle according to the combination of the age, gender, and/or the total number of all the occupants of the vehicle includes: determining whether the more than one occupant is stranger by searching the database; when any one occupant of the more than one occupant is not a stranger, determining a driving mode corresponding to the any one occupant from the database; and when the any one occupant is a stranger, determining a driving mode according to the gender and age of the any one occupant.

In one embodiment, the execution module 302 may further includes: switching the driving mode of the vehicle to a target driving mode according to the determined driving mode corresponding to each of the more than one occupant, the target driving mode being the driving mode that requires the lowest power of the vehicle among all the determined driving modes.

For example, assuming that there are two occupants of the vehicle in total, and the driving modes corresponding to the two occupants include the normal mode and highway mode, then the execution module 302 sets the normal mode as the target driving mode, and the driving mode of the vehicle is switched to the normal mode.

As another example, assuming that there are three occupants of the vehicle in total, and the driving mode corresponding to the three occupants include the sport mode and highway mode, then the execution module 302 switches the driving mode of the vehicle to the sport mode.

In an embodiment of the present disclosure, when the execution module 302 recognizes that one of the more than one occupant is a stranger, and the more than one occupant includes females, elderly, or children, the execution module 302 determines that the driving mode corresponding to the more than one occupant is the normal mode. In another embodiment of the present disclosure, when execution module 302 recognizes that one of the more than one occupant is a stranger, and the more than one occupant only includes males and young people, the execution module 302 determines that the driving mode corresponding to the more than one occupants is the sport mode.

In one embodiment, when the vehicle includes a stranger, the execution module 302 further stores the identity information of the stranger and the current driving mode of the vehicle in the database.

When the second confirmation signal is received, the execution module 302 obtains the road information of the lane where the vehicle is located.

In one embodiment, the road information of the lane where the vehicle is located includes a type of the lane where the vehicle is located, and real-time road conditions of the lane where the vehicle is located.

In one embodiment, the type of the lane where the vehicle is located refers to whether the lane where the vehicle is located is a highway, a mountain road, an urban road, a fast lane, an elevated road, or a slow lane. In an embodiment, the execution module 302 may obtain the type of the lane where the vehicle is located from a high-precision map.

In one embodiment, the real-time road condition of the lane where the vehicle is located refers to whether the road condition of the lane where the vehicle is located is light traffic or heavy traffic.

In one embodiment, the obtaining the real-time road conditions of the lane where the vehicle is located includes: obtaining an external image by taking an image of a scene in front of the vehicle using the camera module; obtaining the real-time road conditions of the lane where the vehicle is located by identifying the external image. In an embodiment, the camera module may further include one or more cameras installed outside the vehicle (hereinafter referred to as external cameras). An installation position of the external camera may be any position outside the vehicle, as long as the execution module 302 can use the one or more external cameras to obtain external images of the vehicle.

In other embodiments, the execution module 302 may obtain the real-time road conditions of the lane where the vehicle is located using a navigation software. In other embodiments, the execution module 302 may also obtain the real-time road conditions of the lane where the vehicle is located through a communication device.

The execution module 302 determines the driving modes of the vehicle according to the occupant attributes of the vehicle and the obtained road information.

In one embodiment, the determines the driving mode of the vehicle according to the occupant attributes of the vehicle and the obtained road information includes: when the vehicle includes only one occupant, and the only one occupant is an elderly person, regardless of the road information of the lane where the vehicle is located, switching a current driving mode of the vehicle to the normal mode; and when the only one occupant is a young person, determining the driving mode according to the obtained road information.

Specifically, when the only one occupant is a young person, the lane where the vehicle is located is a highway or a mountain road, and the traffic in the lane where the vehicle is located is light traffic, the execution module 302 switches the current driving mode to the sport mode; and when the traffic in the lane where the vehicle is located is the heavy traffic, the execution module 302 switches the current driving mode to the normal mode.

For another example, when the occupant is a young person and the lane where the vehicle is located is an urban highway, regardless of whether the traffic in the lane where the vehicle is located is light traffic or heavy traffic, the execution module 302 switches the current driving mode to the normal model.

In one embodiment, the determining the driving mode of the vehicle according to the occupant attributes of the vehicle and the obtained road information includes: when the vehicle includes more than one occupant, and the more than one occupant includes elders or minors, switching the current driving mode of the vehicle to the normal mode regardless of the road information of the lane where the vehicle is located; when the more than one occupant does not include elders and minors, determining the driving mode according to the road information of the lane where the vehicle is located.

For example, when the more than one occupant does not include the elderly and minors, the lane where the vehicle is located is a highway or a mountain road, and the traffic in the lane where the vehicle is located is light traffic, the vehicle-mounded device switches the current driving mode to the sport mode; and when the traffic in the lane where the vehicle is located is heavy traffic, the vehicle-mounded device switches the current driving mode to the normal mode.

In an embodiment of the present disclosure, when the road information of the lane where the vehicle is located is an urban road, and the more than one occupant includes females, the elderly, or children, the execution module 302 determines that the driving mode of the vehicle should be switched to the normal mode. In another embodiment of the present disclosure, when the road information of the lane where the vehicle is located is an expressway, and the more than one occupant only includes young people, the execution module 302 determines that the driving mode of the vehicle should be switched to the highway mode.

In one embodiment, the execution module 302 may not directly switch the driving mode, but recommend the determined driving mode to the driver of the vehicle, and switch the driving mode in response to the driver's input. For example, the execution module 302 may recommend a driving mode using a speaker or a display screen, and determine whether to switch the driving mode of the vehicle in response to the driver's input.

In one embodiment, the execution module 302 further stores manually switched driving mode and the driver's identity in response to detecting a signal that the driver of the vehicle manually switches the driving mode. For example, if the driver manually switches to the normal mode, the execution module 302 stores the normal mode and the driver's identity in the database when detecting the signal that the driver manually switched the driving mode. In one embodiment, the execution module 302 obtains the road information of the lane where the vehicle is located from the high-precision map and obtains real-time road conditions of the lane where the vehicle is located from the navigation software, in response to detecting the signal that the driver of the vehicle manually switches the driving mode; and associating the manually switched driving mode with the obtained road information and real-time road conditions of the lane where the vehicle is located, and storing the associated information.

In one embodiment, the execution module 302 further determines a common driving mode of the driver of the vehicle according to the manually switched driving modes stored in the history. In an embodiment, the execution module 302 may count a number of times each driving mode is manually switched by the driver and set the driving mode with a most number of times as the common driving mode of the driver.

FIG. 3 shows a schematic block diagram of one embodiment of a vehicle-mounted device 3 in a vehicle 100. The vehicle-mounted device 3 is installed in the vehicle 100. The vehicle 100 can be a car or a locomotive. In an embodiment, the vehicle-mounted device 3 may include, but is not limited to, a storage device 31, at least one processor 32, and camera module 33 including at least one camera. The vehicle-mounted device 3 may further include a high-precision map 34, a navigation software 35, and a display screen 36, a GPS device 37, and communication device 38. It should be understood by those skilled in the art that the structure of the vehicle-mounted device 3 shown in FIG. 3 does not constitute a limitation of the embodiment of the present disclosure.

The vehicle-mounted device 3 may further include other hardware or software, or the vehicle-mounted device 3 may have different component arrangements. In at least one embodiment, the vehicle-mounted device 3 may include a terminal that is capable of automatically performing numerical calculations and/or information processing in accordance with pre-set or stored instructions. The hardware of terminal can include, but is not limited to, a microprocessor, an application specific integrated circuit, programmable gate arrays, digital processors, and embedded devices.

It should be noted that the vehicle-mounted device 3 is merely an example, and other existing or future electronic products may be included in the scope of the present disclosure, and are included in the reference.

In some embodiments, the storage device 31 can be used to store program codes of computer readable programs and various data, such as the driving assistance system 30, the high-precision map 34, and the navigation software 35 installed in the vehicle-mounted device 3, and automatically access to the programs or data with high speed during the running of the vehicle-mounted device 3. The storage device 31 can include a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the vehicle-mounted device 3 that can be used to carry or store data.

In some embodiments, the at least one processor 32 may be composed of an integrated circuit, for example, may be composed of a single packaged integrated circuit, or multiple integrated circuits of same function or different functions. The at least one processor 32 can include one or more central processing units (CPU), a microprocessor, a digital processing chip, a graphics processor, and various control chips. The at least one processor 32 is a control unit of the vehicle-mounted device 3, which connects various components of the vehicle-mounted device 3 using various interfaces and lines. By running or executing a computer program or modules stored in the storage device 31, and by invoking the data stored in the storage device 31, the at least one processor 32 can perform various functions of the vehicle-mounted device 3 and process data of the vehicle-mounted device 3. For example, the function of performing the driving assistance for vehicle 100 as described in FIG. 1.

In one embodiment, the camera module 33 can include one or more internal cameras that are installed at any position inside the vehicle 100 and include one more external cameras that are installed outside the vehicle 100. The internal cameras are used to capture images of all occupants of the vehicle 100. The external cameras are used to capture images of a scene outside the vehicle 100.

In one embodiment, the GPS device 37 can receive satellite signals of a global positioning system (abbreviated as: GPS), an assisted global positioning system (abbreviated as: AGPS), a Beidou satellite navigation system (abbreviated as: BDS), or a GLOBAL NAVIGATION SATELLITE SYSTEM (abbreviated as: GLONASS). The vehicle-mounted device 3 can use the GPS device 37 to locate latitude and longitude of a current location of the vehicle 100, and obtain a driving speed of the vehicle 100.

The communication device 38 can be Wireless Fidelity (WIFI), Global System for Mobile Communications (GSM), General Packet Radio Service (GPRS), code division Multiple access (CDMA), Wideband Code Division Multiple Access (W-CDMA), or any type of wireless communication module.

The display screen 36 may be a touch display screen for displaying various data of the vehicle-mounted device 3, for example, displaying the high-precision map 34 and a user interface of the navigation software 35. In one embodiment, the high-precision map 34 may be a Baidu high-precision map or other maps such as a Google high-precision map. In one embodiment, the high-precision map 34 can indicate whether each road is a highway, an urban road, or a mountain road. In addition, the high-precision map 34 also can indicate intersections included in each lane, traffic rules of each intersection, and the like.

In one embodiment, integrated unit implemented in the form of a software function module can be stored in a non-volatile readable storage medium. The above-mentioned software function module includes one or more computer-readable instructions, and the vehicle-mounted device 3 or a processor implements part of the method of each embodiment of the present disclosure by executing the one or more computer-readable instructions. For example, the driving assistance method as shown in FIG. 1. In at least one embodiment, as shown in FIG. 2, the at least one processor 32 can execute various types of applications (such as the driving assistance system 30) installed in the vehicle-mounted device 3, program codes, and the like. For example, the at least one processor 32 can execute the modules 301-302 of the driving assistance system 30.

In at least one embodiment, the storage device 31 stores program codes. The at least one processor 32 can invoke the program codes stored in the storage device to perform functions. For example, the modules described in FIG. 2 are program codes stored in the storage device 31 and executed by the at least one processor 32, to implement the functions of the various modules for the purpose of realizing the driving assistance as described in FIG. 1. In at least one embodiment, the storage device 31 stores one or more instructions (i.e., at least one instruction) that are executed by the at least one processor 32 to achieve the purpose of realizing the driving assistance as described in FIG. 1. In at least one embodiment, the at least one processor 32 can execute the at least one instruction stored in the storage device 31 to perform the operations of as shown in FIG. 1.

The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A driving assistance method applied to a vehicle comprising a camera module, the driving assistance method comprising:
capturing at least one image of occupants of the vehicle using the camera module;
recognizing occupant attributes of the vehicle based on the captured at least one image; and
determining a driving mode of the vehicle based on the occupant attributes of the vehicle.

2. The driving assistance method as claimed in claim 1, wherein the occupant attributes of the vehicle comprise a total number of occupants of the vehicle, an identity of the driver, an age of the driver, a gender of the driver, an identity of each passenger, and an age and a gender of each passenger.

3. The driving assistance method as claimed in claim 2, wherein the determining the driving mode of the vehicle based on the occupant attributes of the vehicle comprises:
when the occupant attributes indicate that the vehicle comprises only one occupant, switching a current driving mode of the vehicle to the driving mode corresponding to the identity of the only one occupant.

4. The driving assistance method as claimed in claim 2, wherein the determining the driving mode of the vehicle based on the occupant attributes of the vehicle comprise:
switching the driving mode of the vehicle according to a combination of the age, the gender, and/or the total number of all the occupants of the vehicle, when the occupant attributes indicate that the vehicle comprise more than one occupant.

5. The driving assistance method as claimed in claim 4, wherein the determining the driving mode of the vehicle according to the combination of the age, the gender, and/or the total number of all the occupants of the vehicle comprises:
determining whether the more than one occupant is a stranger by searching a database;
when any one occupant of the more than one occupant is not a stranger, determining the driving mode corresponding to the any one occupant by the database; and
when the any one occupant is a stranger, determining the driving mode according to the gender and the age of the any one occupant.

6. The driving assistance method as claimed in claim 5, further comprising:
switching the driving mode of the vehicle to a target driving mode according to the determined driving mode corresponding to each of the more than one occupant, the target driving mode being the driving mode that requires a lowest power of the vehicle among all the determined driving modes.

7. The driving assistance method as claimed in claim 1, further comprising:
obtaining road information of the lane where the vehicle is located; and
determining the driving mode of the vehicle according to the occupant attributes of the vehicle and the obtained road information.

8. The driving assistance method as claimed in claim 7, wherein the road information of the lane where the vehicle is located comprises: a type of the lane where the vehicle is located, and real-time road conditions of the lane where the vehicle is located.

9. The driving assistance method as claimed in claim 8, further comprising:
obtaining the type of the lane where the vehicle is located from a high-precision map;
wherein the obtaining the real-time road conditions of the lane where the vehicle is located comprises:
obtaining the real-time road conditions of the lane where the vehicle is located by identifying an external image, wherein the external image is obtained by taking an image of a scene in front of the vehicle using the camera module; or
obtaining the real-time road conditions of the lane where the vehicle is located from a navigation software or a communication device.

10. A vehicle-mounted device comprising:
a camera module;
at least one processor; and
a storage device storing one or more programs, which when executed by the at least one processor, cause the at least one processor to:
capture at least one image of occupants of the vehicle using the camera module;
recognize occupant attributes of the vehicle based on the captured at least one image; and
determine a driving mode of the vehicle based on the occupant attributes of the vehicle.

11. The vehicle-mounted device as claimed in claim 10, wherein the occupant attributes of the vehicle comprise a total number of occupants of the vehicle, an identity of the driver, an age of the driver, a gender of the driver, an identity of each passenger, and an age and a gender of each passenger.

12. The vehicle-mounted device as claimed in claim 11, wherein the determining the driving mode of the vehicle based on the occupant attributes of the vehicle comprises:
when the occupant attributes indicate that the vehicle comprises only one occupant, switching a current driving mode of the vehicle to the driving mode corresponding to the identity of the only one occupant.

13. The vehicle-mounted device as claimed in claim 11, wherein the determining the driving mode of the vehicle based on the occupant attributes of the vehicle comprise:
switching the driving mode of the vehicle according to a combination of the age, the gender, and/or the total number of all the occupants of the vehicle, when the occupant attributes indicate that the vehicle comprise more than one occupant.

14. The vehicle-mounted device as claimed in claim 13, wherein the determining the driving mode of the vehicle according to the combination of the age, the gender, and/or the total number of all the occupants of the vehicle comprises:
determining whether the more than one occupant is a stranger by searching a database;
when any one occupant of the more than one occupant is not a stranger, determining the driving mode corresponding to the any one occupant by the database; and
when the any one occupant is a stranger, determining the driving mode according to the gender and age of the any one occupant.

15. The vehicle-mounted device as claimed in claim 14, further comprising:
switching the driving mode of the vehicle to a target driving mode according to the determined driving mode corresponding to each of the more than one occupant,
the target driving mode being the driving mode that requires a lowest power of the vehicle among all the determined driving modes.

16. The vehicle-mounted device as claimed in claim 10, wherein the at least one processor is further caused to:
obtain road information of the lane where the vehicle is located; and
determine the driving mode of the vehicle according to the occupant attributes of the vehicle and the obtained road information.

17. The vehicle-mounted device as claimed in claim 16, wherein the road information of the lane where the vehicle is located comprises: a type of the lane where the vehicle is located, and real-time of the lane where the vehicle is located.

18. The vehicle-mounted device as claimed in claim 17, wherein the at least one processor is further caused to:
obtain the type of the lane where the vehicle is located from a high-precision map;
wherein the obtaining the real-time road conditions of the lane where the vehicle is located comprises:
obtaining the real-time road conditions of the lane where the vehicle is located by identifying an external image, wherein the external image is obtained by taking an image of a scene in front of the vehicle using the camera module; or
obtaining the real-time road conditions of the lane where the vehicle is located from a navigation software or a communication device.
